(19) United States
(12) Patent Application Publication
(10) Pub. No.: US 2002/0025212 A1
(43) Pub. Date: Feb. 28, 2002

(54) Brush-n-go

(76) Inventor: Michael Davis, Petrolia, TX (US)

Correspondence Address: Michael Davis, Box 254, 503 Magnolia, Petrolia, TX, 76377, US

(21) Appl. No.: 09/866,333

(22) Filed: May 25, 2001

Related U.S. Application Data
(60) Provisional application No. 60/227,261, filed on Aug. 24, 2000.

(51) Int. Cl. B43K 5/06

(52) U.S. Cl. 401/175; 401/270

(57) ABSTRACT

Brush-n-go is the first all in one toothbrush, that can be used away from home as well as at home. This disposable toothbrush is designed to be used many times before replacement is needed. The handle size of the toothbrush will determine the longevity of each toothbrush. My invention is a toothbrush and toothpaste all in one. The toothpaste for this toothbrush will be concealed in the handle. A one way valve will release the toothpaste into the brushes of this toothbrush. Opposite the brush end of the brush-n-go their will be a twist knob to regulate the need of toothpaste, per each use. Simply twist the knob and the toothpaste will be forced out the one way valve into the brushes of the brush-n-go. After use just clean brushes with water and the brush-n-go will be ready to go.

### BACKGROUND OF THE INVENTION

1. Field of the invention

This invention is related to a toothbrush and in particular a disposable yet reusable toothbrush which consist of a toothbrush and toothpaste all in one.

2. Description of the prior art

It has been found that the conventional toothbrush is used primarily in the home. However with a toothbrush and toothpaste all in one, users will have more opportunities to brush outside of said home.

Therefore, it is the object of the present invention to provide a disposable yet convenient toothbrush and toothpaste all in one.

### SUMMARY OF THE INVENTION

This invention is related to a toothbrush and in particular a disposable yet reusable toothbrush which consist of a toothbrush and toothpaste all in one.

According to a preferred embodiment of the present invention, a disposable yet reusable toothbrush which consist of a toothbrush and toothpaste all in one, includes a head provided with bristles with an opening in the center of the head at a front end of handle, An elongated tubular handle with the cavity of said handle having a circular hole aligned attaching to the bristle head opening, A one way valve located at the base of the bristle head circular opening, A male threaded rod aligned in the cavity of said handle, A base plate located opposite end of said head, A twist knob located at handles end attached to threaded rod in said handle, Whereby toothpaste can be regulated in the toothbrush handle for use as desired.

The foregoing objects and summary provide only a brief introduction to the present invention. To fully appreciate these and other objects of the present invention as well as the invention itself, all of which will become apparent to those skilled in the art. The following detailed description of the invention and claims should be read in conjunction with the accompanying drawings. Throughout the specifications and drawings identical reference numbers refer to identical or similar parts. Many other advantages and features of the present invention will become manifest to those versed in the art, upon making reference to the detailed description and the accompanying sheets of drawings in which a preferred structural embodiment incorporating the principles of the present invention is shown by way of illustrative example.

### BRIEF DESCRIPTION OF DRAWING

FIG. 1 Is a perspective view of the present invention;

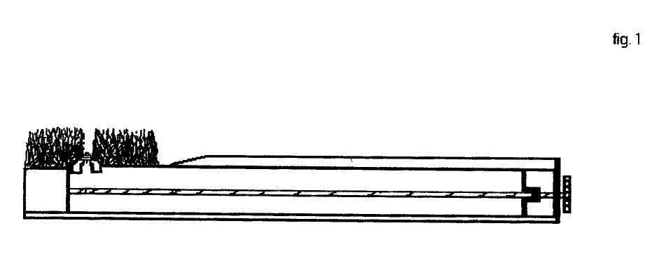

FIG. 2 Is an exploded view of the present invention;

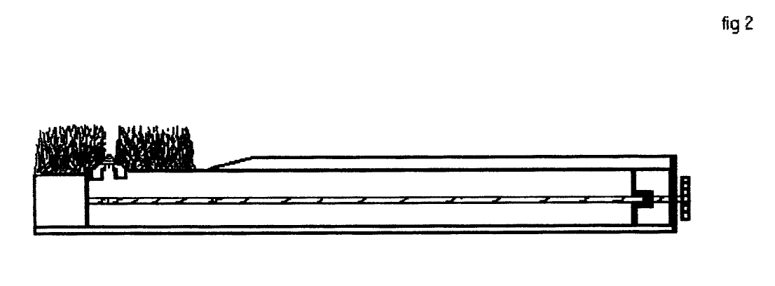

FIG. 3 Illustrates the working principle of the present invention;

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

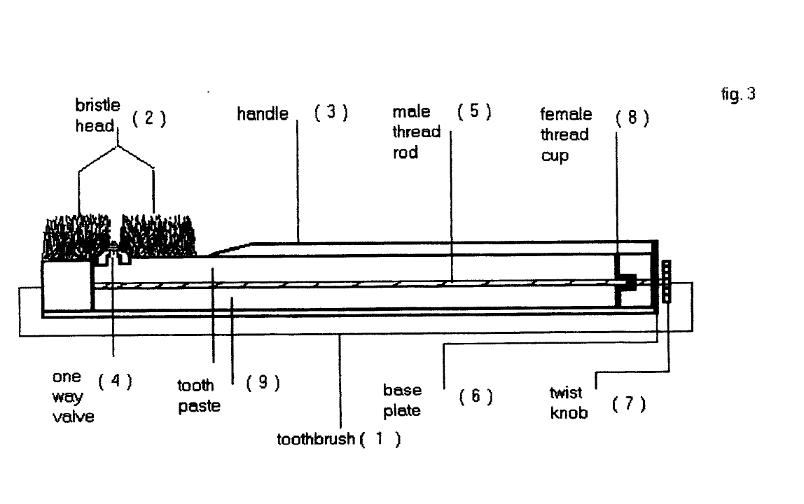

With reference to the drawings and in particular to FIG. 3 therefore, toothbrush 1 according to the present invention generally comprises a bristle head 2, a handle 3, a one way valve 4, a male threaded rod 5, a base plate 6, a knob 7, a female threaded rotator cup 8, and toothpaste 9. The head 2 is provided with bristles, with the base of the head having an opening enabling toothpaste 9 to be released into the bristle head 2. The handle 3 is an elongated tubular member having a hollow cavity. The one way valve 4 is located at the base of said head 2. The threaded rod 5 is in conjunction with the base plate 6 as well as the knob 7. The rotator cup 8 rotates on rod 5, when the knob 7 is turned. The toothpaste 9 is located inside the cavity of handle 3.

In assembly, the handle 3, will be filled with toothpaste 9. Thereafter the male threaded rod 5, the base plate 6, the knob 7, will be sealed opposite end of the toothbrush head 2. The base plate 6 is stationary so that when the knob 7, is turned the male threaded rod 5, will turn as well. The rotator cup 8, will rotate down the rod 5, as the knob 7, is turned. The cup 8, will force the toothpaste 9, out the one way valve 4, into the bristle head 2.

It will be understood that each of the elements described above, or two or more together, may also find a useful application in other types of methods differing from the type described above.

While certain novel features of this invention have been shown and described and are pointed out in the annexed claim, it is not intended to be limited to the details above. Since it will be understood that various omissions, modifications, substitutions, and changes in the forms, and details of the device illustrated and in its operation can be made by those skilled in the art, without departing in any way, from and spirit of the present invention.

I claim:

1. A disposable yet reusable toothbrush which consist of a toothbrush and toothpaste all in one, comprising:
a head provided with bristles with an opening in the center of the head at a front end of said toothbrush;
an elongated tubular handle with the cavity of said handle having a circular hole to conceal toothpaste which is aligned with the bristle head opening.

2. The toothbrush as defined in claim one, comprising:
a one way valve located at the center base of the head opening;
a male threaded rod aligned in the center cavity of said handle from head opening to the base which is located at the opposite end of the said head;
a round female threaded rotator cup which will rotate around said threaded rod;
a twist knob located at the handles end attached to the said threaded rod in said handle;
a toothpaste concealed in handle of said toothbrush.
